(19) United States
(12) Patent Application Publication
(10) Pub. No.: US 2015/0003340 A1
(43) Pub. Date: Jan. 1, 2015

(54) INFORMATION PROCESSING APPARATUS AND INFORMATION PROCESSING METHOD

(71) Applicant: KABUSHIKI KAISHA TOSHIBA, Tokyo (JP)

(72) Inventor: Toshihiro Morohoshi, Kawasaki-shi (JP)

(73) Assignee: KABUSHIKI KAISHA TOSHIBA, Tokyo (JP)

(21) Appl. No.: 14/242,306

(22) Filed: Apr. 1, 2014

(30) Foreign Application Priority Data
Jun. 28, 2013 (JP) 2013-137230

(51) Int. Cl. H04W 72/04; H04W 12/04

(52) U.S. Cl. CPC H04W 72/0406; H04W 12/04
USPC 370/329

(57) ABSTRACT

An information processing apparatus is configured to perform function setting for a medium capable of operating as an access point, which includes setting storage, a processor and a transmitter. The setting storage is configured to store setting information of functions. The processor is configured to generate commands to switch from a second access point other than the medium to the access point of the medium and to operate the medium as the access point by using the setting information. The transmitter is configured to transmit the command to the medium. The processor is further configured to generate a command to return from the access point of the medium to the second access point when terminating operation of the medium as the access point, and the transmitter is further configured to transmit the command to the second access point.

### CROSS-REFERENCE TO RELATED APPLICATION(S)

This application is based upon and claims the benefit of priority from Japanese Patent Application No. 2013-137230, filed on Jun. 28, 2013, the entire contents of which are incorporated herein by reference.

### FIELD

Embodiments described herein relate generally to an information processing apparatus and an information processing method.

### BACKGROUND

A digital television receiver (DTV) has recently incorporated a wireless local area network (WLAN) function as a standard feature. An SD card type medium (device) having functions of WLAN and medium has been put on the market.

Conventionally, when a WLAN function is used in a conventional DTV, it is common to connect a contents service provider (CSP). Thus, it is usual to connect an access point for outside Internet connection. As to medium such as having an access point function, a network client has to switch a current connected access point to a medium, which is required to enter connection information (e.g., an encryption key) at each time for connecting an access point on a setting window.

There has been a demand to solve such a problem, but a means to realize the demand has not been known.

### BRIEF DESCRIPTION OF THE DRAWINGS

FIG. 1 is a schematic diagram of a wireless connection system according to an embodiment.

FIG. 2 is a block diagram showing an exemplary configuration of a portable imaging device according to an embodiment.

FIG. 3 is a block diagram showing an exemplary configuration of an electronic apparatus (a television) of a side to set wireless LAN connection in a medium, which is used in a wireless connection system according to an embodiment.

FIG. 4 is a diagram showing functional blocks around a medium of a side that wireless LAN connection is set from an electronic apparatus (television) 50 or the like, which is used in a wireless connection system according to an embodiment.

FIG. 5 is diagram showing functional blocks of an electronic apparatus (TV) of a side to set wireless LAN connection for an electronic device (a portable imaging device) 40, which is used in a wireless connection system according to an embodiment.

FIG. 6 is a flowchart explaining a setting preparation operation used in a wireless connection system according to an embodiment.

FIG. 7 is a flowchart explaining a setting operation used in a wireless connection system according to an embodiment.

### DETAILED DESCRIPTION

According to one embodiment, an information processing apparatus performs function setting for a medium having a function as an access point. The information processing apparatus includes a setting storage module, a command generator which is a processor and a transmitter. The setting storage module stores setting information of functions. The command generator generates a command (i) to switch from another access point other than the medium to the access point of the medium and (ii) to operate the medium as the access point by using the setting formation. The transmitter transmits the command to the medium. The command generator generates a command to return from the access point of the medium to said another access point other than the medium when terminating operation of the medium as the access point, and the transmitter transmits the command to said another access point other than the medium.

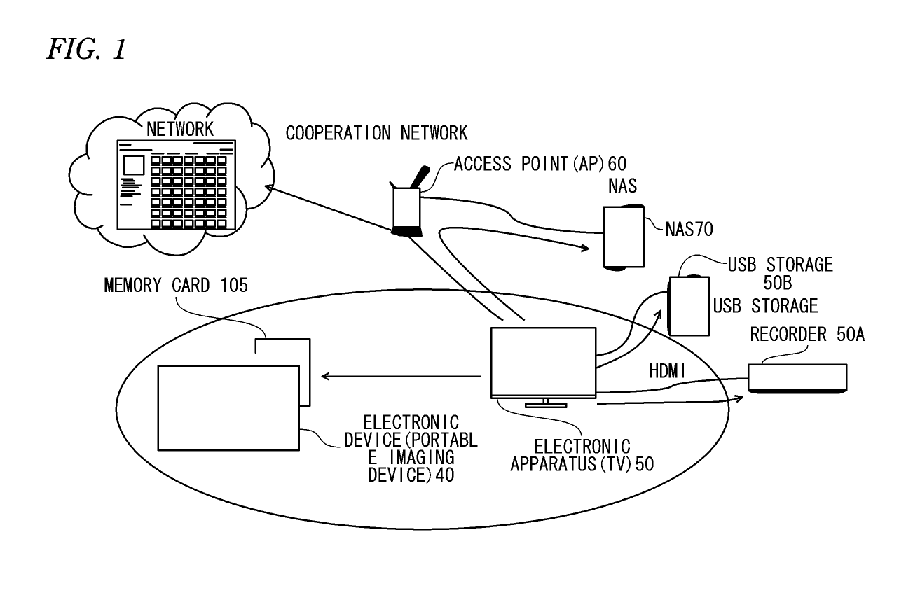

Various embodiments will be described hereinafter with reference to the accompanying drawings, FIG. 1 to FIG. 7.

FIG. 1 is a schematic diagram of a wireless connection system according to an embodiment.

In an architecture for communication among multiple terminals, a connection form of a wireless LAN observing from a client side is roughly divided into two modes, whether or not an access point is used. One mode where an access point is used is called as in an infrastructure mode. Namely, a wireless LAN client makes communication through an access point.

Therefore, in the embodiment, as shown in FIG. 1, firstly an electronic apparatus (TV) 50 is configured to be wirelessly connectable through an access point (AP) 60. The electronic apparatus (TV) 50 is connected to a recorder 50A via an HDMI (registered trademark), and is connected to a USB storage 50B via a USB interface. The electronic apparatus (TV) 50 is configured to be connectable also to a NAS 70 through the access point (AP) 60.

An electronic device (a portable imaging device) 40 is provided with a memory card 105 as a medium. As an example of such a medium, there is FlashAir (a registered trademark). In the medium, a wireless LAN function is incorporated into an SD card, and an SD card is provided with an access point function and an HTTP server. Thus, photos taken by the portable imaging device and stored in the memory card can be viewed and saved in the web browser by connecting a personal computer, or by connecting an access point of the SD card when using a smartphone, a tablet or the like.

The electronic apparatus (TV) has to be connected to the access point (AP) 60 for accessing so-called the Internet. However, a connection destination of the wireless LAN has to be changed in case of viewing photos from the electronic device (portable imaging device) 40 that is provided with the wireless LAN function built-in SD card 41.

As for the switching, selection buttons such as AP1 and AP2 might be aligned under an operation prompt such as “Select a connecting access point”, for example, on a display screen. By selecting an appropriate button, access to the Internet and wireless LAN function built-in SD card can be switched. On the other hand, eliminating such a cumbersome step can be realized by connecting to the access point 60 all the time, and select “Play photos of the wireless LAN function built-in SD card 41” on the operation menu. Then, the access point 60 can be automatically switched to the SD card 41 inside the program.

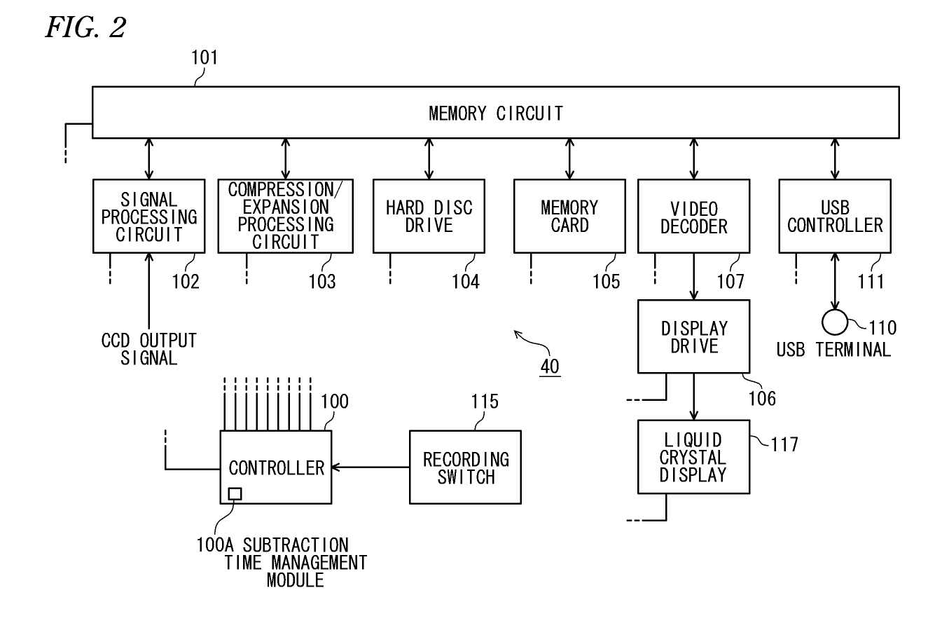

FIG. 2 is a block diagram showing an exemplary configuration of a portable imaging device according to the embodiment. The drawing shows the essential parts of a portable imaging device 40.

The block diagram mainly shows a CCD (charged-coupled devices) or CMOS output signal processing system based on a moving image captured by a solid imaging element of the portable imaging device 40. The processing system includes a controller 100 to control operations of each unit, a memory circuit 101, a signal processing circuit 102, a compression/expansion processing circuit 103, a hard disc drive 104, a memory card 105, a display drive 106, a video decoder 107, an USB controller 111 connected to a USB terminal 110, and a liquid crystal display 117.

The memory circuit 101 is provided between the controller 100 and each component, and temporarily stores a signal having a large amount of data outputted from the controller 100.

The signal processing circuit 102 performs predetermined signal processing for a CCD output signal that is an image signal.

The compression/expansion processing circuit 103 performs compression/expansion processing for a CCD output signal depending on a still image and a moving image. In the embodiment, compression/expansion processing based on the joint photographic expert group (JPEG) standard is performed for a still image, and compression/expansion processing based on the motion picture experts group (MPEG) standard is performed for a moving image.

The hard disc drive 104 is a storage that manages still images, moving images, and other data recorded based on file systems such as FAT and NTFS.

The video decoder 107 decodes a CCD output signal based on an image captured by a not-shown imaging element, processes a signal for displaying on the liquid crystal display 117, and outputs the signal to the display drive 106.

The USB controller 111 transmits/receives still image or moving image data to/from a personal computer (PC) or other electronic devices via the USB terminal 110.

The controller 100 includes a subtraction time management module 100A, which is activated when a recording switch 115 is externally pressed, and when the amount of moving image file data recorded on the hard disc drive 104 or memory card 105 becomes close to 8 GB. For example, the subtraction time management module 100A executes a switching operation to switch a display mode such as from an elapsed time for the moving image , which is displayed on the display screen of the liquid crystal display 117, to the subtraction time mode displaying the remaining time before reaching 8 GB, which is executed based on preset conditions.

A CCP output signal is converted to a digital signal by a not-shown A/D converter, and applied to the camera signal processing circuit 102 for predetermined signal processing. The signal is compressed by the compression/expansion processing circuit 103, and recorded on the hard disc drive 104 or memory card 105 via the memory circuit 101. At this time, a captured image is displayed on the liquid display 117 through the display drive 106 via the video decoder 107.

At playback, an image read out from the hard disc drive 104 or memory card 105 is applied to the compression/expansion processing circuit 103 via the memory circuit 101, and after being expanded, the signal is outputted to the video decoder 107 via the memory circuit 101, and displayed on the liquid crystal display 117 through the display drive 106.

When transferring or receiving a still image or a moving image recorded on the hard disc drive 104 or memory card 105 to/from an external device, transmit or receive the image from the USB terminal 110 via the USB controller 111.

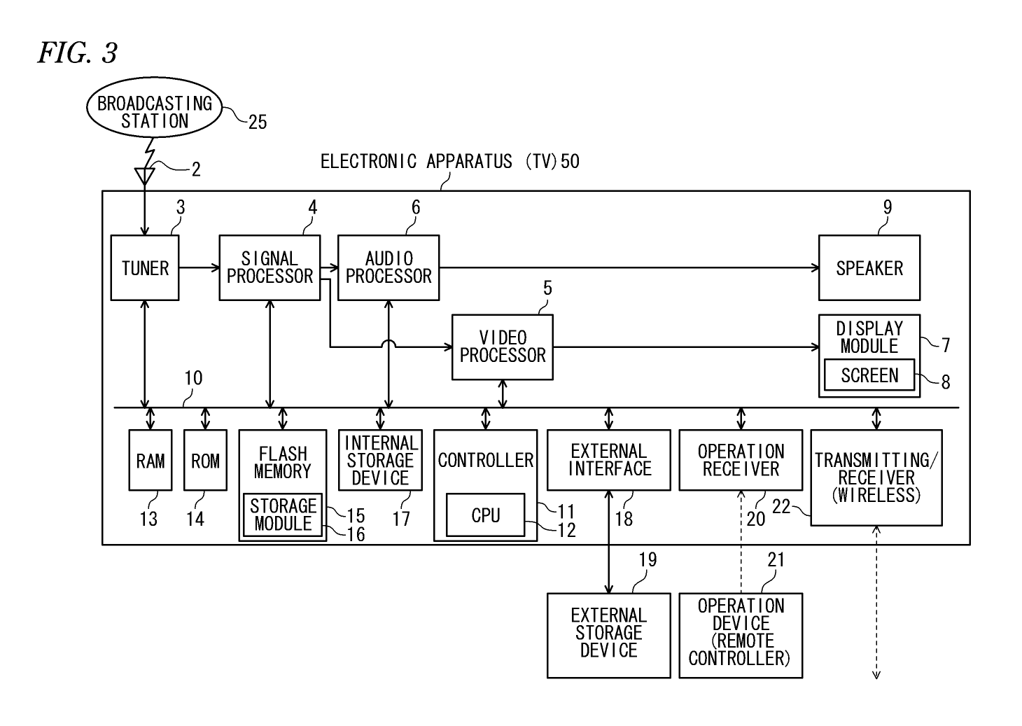

FIG. 3 is a block diagram showing an exemplary configuration of an electronic apparatus (TV) of a side to set wireless LAN connection in a medium, which is used in the wireless connection system according to the embodiment.

In the embodiment, the controller 11 is provided with a CPU (12). The CPU (12) controls the electronic apparatus (television) 50.

A RAM (13), a ROM (14), and a flash memory 15 are used for a processing that is performed by the controller 11.

The flash memory 15 can also store information about devices set by the system and preset information about a user.

Video content is broadcasted as digital broadcast from a broadcasting station 25, for example. The digital broadcast from the broadcasting station 25 is received by a tuner 3, tuned, and video content of a digital signal is transmitted to a signal processor 4.

The vide content of the digital signal received by the signal processor 4 is subjected to signal processing, and is transmitted to an audio processor 6 and a video processor 5.

The audio processor 6 receives the signal processed video content, and transmits an audio processed signal to a speaker 9.

The speaker 9 receives the audio processed signal, and outputs a sound.

The video processor 5 receives the signal processed video content, and transmits the video processed signal to a display module 7.

The display module 7 receives the video processed signal, and displays an image on a display screen (a video display module) 8 comprising an LCD panel or the like.

Further, in the embodiment, the electronic apparatus (television) 50 is provided with an external storage device 19 that is connected to an USB or LAN as described above. The received video content can be recorded in the external storage device 19.

Further, in the embodiment, the electronic apparatus (television) 50 is provided with an internal storage device 17. The internal storage device 17 can fully record a received broadcast program like the external storage device 19, and play it on a time shift base.

Further, as described above, user operations for the electronic apparatus (television) 50 are instructed by an operation device such as a remote controller 21 or the like.

These processing are controlled by the controller 11 as described above.

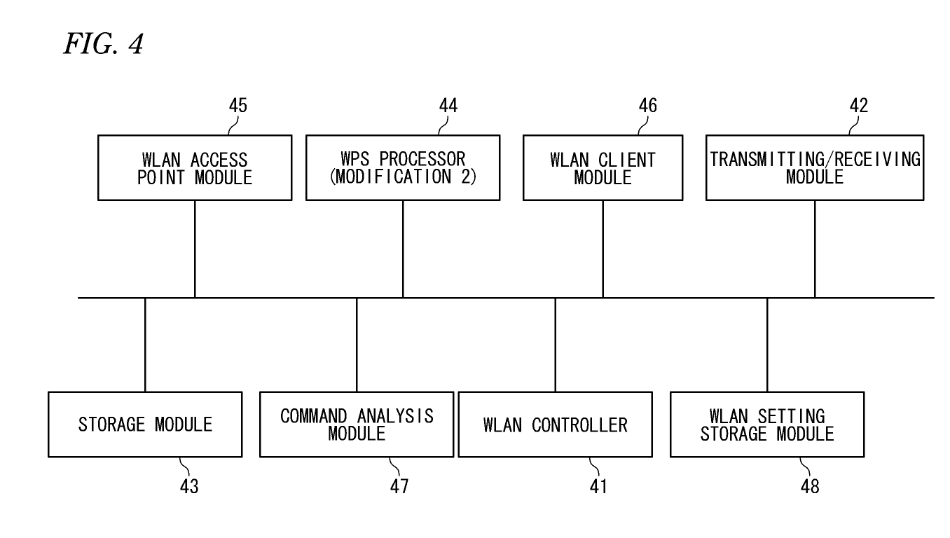

FIG. 4 is a diagram showing functional blocks around the memory card 105 of the electronic device (portable imaging device) 40 of a side that wireless LAN connection is set from the electronic apparatus (television) 50 or the like, which is used in the wireless connection system according to the embodiment.

In the embodiment, as shown in FIG. 4, the memory card 105 being supplied with resources such as power to the electronic device (portable imaging device) 40 configures a WLAN controller 41, a transmitting/receiving module 42, a storage module 43, a WPS processor 44, a WLAN access point module 45, a WLAN client module 46, a command analysis module 47, and a WLAN setting storage module 48.

The transmitting/receiving module 42 performs data transmission and reception. The storage module 43 stores photos and moving images. The WPS processor 44 performs Wi-Fi protected setup (WPS) (a registered trademark). The WLAN access point module 45 operates as an access point of WLAN. The WLAN client module 46 operates as a client of WLAN.

The command analysis module 47 analyzes a command received from the transmitting/receiving module 42, and obtains WLAN setting information. The WLAN controller 41 performs wireless LAN processing, and switches operations of an access pint and a client. The obtained WLAN setting information is stored in the WLAN setting storage module 48, and an access point is connected via the WLAN client module 46. The WLAN setting storage module 48 stores information about connection to an access point.

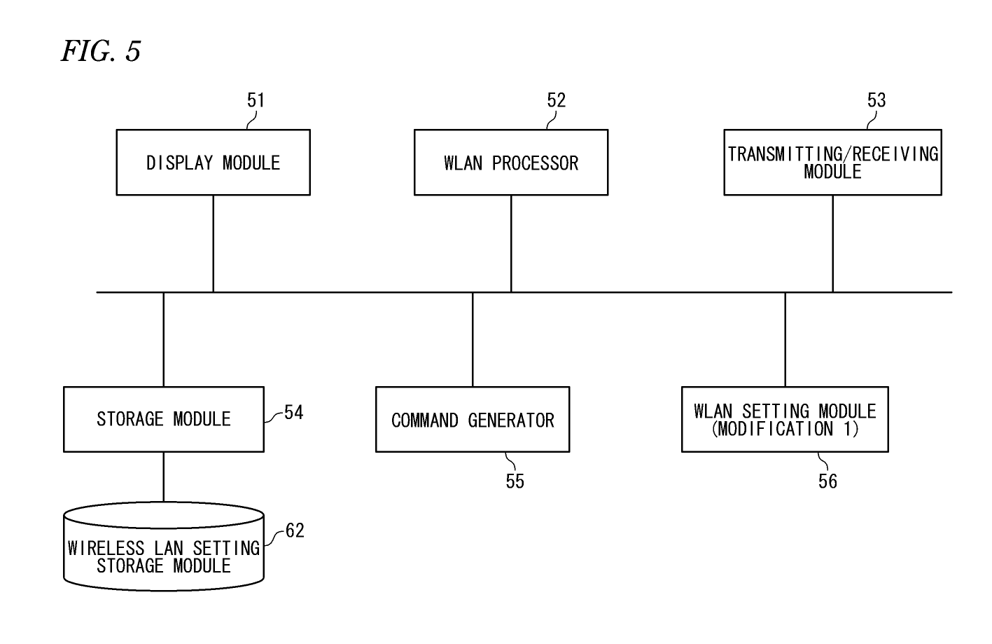

FIG. 5 is diagram showing functional blocks of the electronic equipment (TV) 50 of a side to set wireless LAN connection for the electronic device (portable imaging device) 40, which is used in the wireless connection system according to the embodiment.

In the embodiment, as shown in FIG. 5, the electronic apparatus (TV) 50 configures a display module 51, a WLAN processor 52, a transmitting/receiving module 53, a storage module 54, a command generator 55, a WLAN setting module 56, and a wireless LAN setting storage module 62.

The display module 51 displays connection to a side to be set and a user interface (UI) concerning WLAN setting. For example, results of scanning an electronic device connectable to the electronic apparatus (TV) 50 are displayed. The WLAN processor 52 operates as a wireless LAN client. The transmitting/receiving module 53 transmits and receives data.

The storage module 54 stores an UI. The command generator 55 generates a command related to information about connection to a wireless LAN access point in the side to be set.

The WLAN setting module 56 performs processing for the user to perform WLAN setting through an UI. The wireless LAN setting storage module 62 stores setting of a wireless LAN.

The wireless LAN setting storage module 62 stores an SSID (a service set identifier) and KEY (a key, a network key) required for wireless LAN connection.

The SSID mentioned here is an abbreviation of a service set identifier, which is an identifier of an access point in the IEEE 802. 11 series wireless LAN, for example. It is a name given to avoid interference, and can be set by up to 32 alphanumeric characters. For example, an SSID of the access point (AP) 60 is “HOMEGATE”.

Further, an ESSID is a name given to a network identifier that is expanded considering a network provided having multiple access points. An SSID may be called as an ESSID.

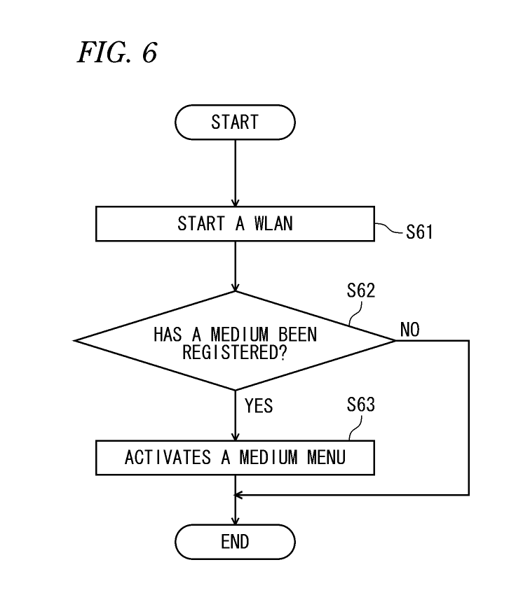

FIG. 6 is a flowchart explaining a setting preparation operation used in the wireless connection system according to the embodiment. The electronic apparatus (TV) 50 may execute this routine once after the power is turned on, for example. Conventionally, when a medium device is connected while a TV is using a WLAN function, it is necessary to once disconnect from a WLAN access point, and to switch to a medium by the user's instruction.

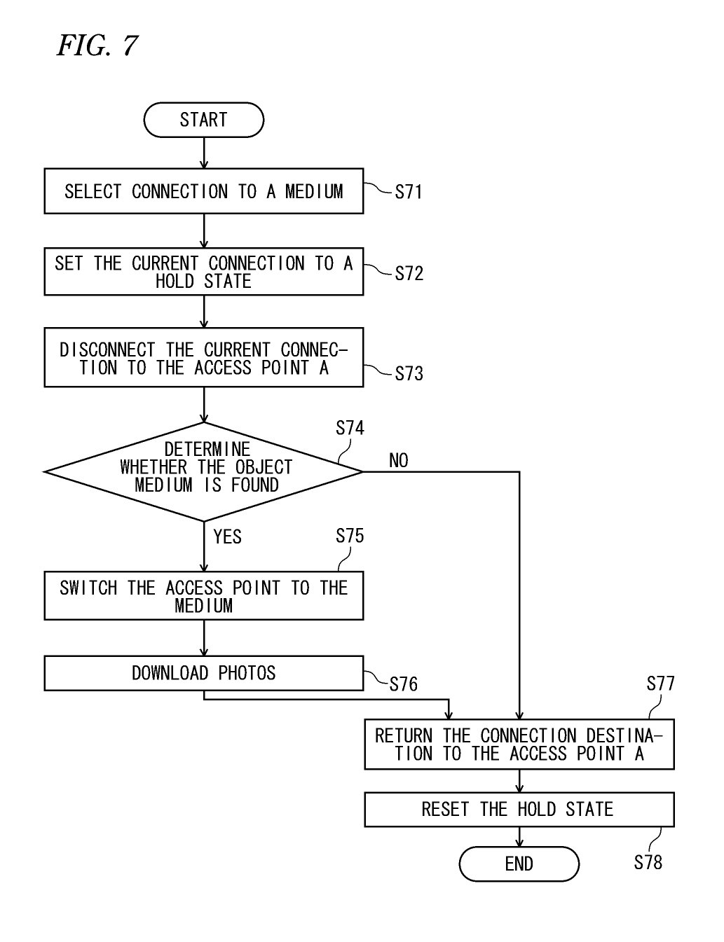

Hereinafter, up to FIG. 7, a TV is configured to register an access point A for connection to outside and information about medium access, and to automatically switch an access destination when connection to a medium is selected. For an application that is already connected to an access point A, a TV waits for a response. Thus, when a hold state is set in an application, for example, and this state is encountered, an access to an eternal network is temporarily interrupted, and data from a network seems to be waited.

Step S61: The WLAN setting module 56 starts a WLAN.

Step S62: The WLAN setting module 56 determines whether a medium (a memory card 105) has been registered by referring to the wireless LAN setting storage module 62, and go to the next step when a medium has been registered, and terminates the processing when a medium has not been registered.

Step S63: The WLAN setting module 56 activates a medium menu. The menu may be placed in a quick menu list displayed on the display screen 8 by operating a not-shown quick button or the like of the remote controller 21. A TV may be configured so that the user presses an enter button (not-shown) of the remote controller 21 to select from the medium menu (refer to FIG. 7).

FIG. 7 is a flowchart explaining a setting operation used in the wireless connection system according to the embodiment. The chart shows a case where a TV downloads all JPEG files from a medium (downloads photos from a digital camera in which a medium is set). A TV previously registers an access point for connection to outside and information about medium access. When connection to a medium is selected, a TV switches an access destination, and for an application that is already connected to an access point, sets a socket layer to a hold state to wait for a response.

Step S71: When the user operates the remote controller 21 to give an instruction to a medium menu, the WLAN setting module 56 selects connection to a medium.

Step S72: The WLAN setting module 56 sets the current connection to a hold state. A low-order socket layer is set to a hold state by application software. This means the following state. The WLAN processor 52 obtains a response by sending a URL to the current access point for accessing to outside. Even if the response cannot be obtained, the WLAN processor 52 does not assume it an error, and sets it to a response waiting state. Thus, the WLAN setting module 56 does not make complete disconnection.

Step S73: The WLAN setting module 56 disconnects the current connection to the access point A (the access point (AP) 60)).

Step S74: The command generator 55 starts the sequence of connecting the medium memory card 105 to the access point (AP) 60. When the command generator 55 scans a LAN, a response is obtained from an access point of each channel of the LAN. At this time, the command generator 55 determines whether an object medium is found.

Step S75: When the command generator 55 determines that the object medium is found, in step S74, the WLAN processor 52 switches the access point to the medium.

In general, a prompt to enter a key for connecting to an object medium appears on the TV screen, and the user enters a known key. Then, the electronic apparatus (television) 50 connects the medium, and commands an access point setting information (SSID, encryption method, encryption key). The encryption method might be WPA2-PSK/AES, for example.

However, in step S63, the WLAN setting module 56 registers the access point A for the connection to the outside as well as the information for accessing a medium (the above setting information) as a set assumed to have been linked to the medium menu. Therefore, the WLAN processor 52 can switch the access point to the medium without requesting the user to enter the setting information at this time.

Step S76: Photos are downloaded from the memory card 105 to the electronic apparatus (television) 50.

Step S77: When the command generator 55 determines that the object medium is not found, in step S74, or when step S76 is completed, the WLAN processor 52 returns the connection destination to the access point A.

Step S78: The WLAN processor 52 resets the hold state.

As described above, the TV creates a medium (download) menu, and when the user selects the menu, the following steps are automatically executed.
(1) The TV switches the access point to the medium.
(2) The TV connects the medium by an HTTP protocol or the like, and downloads all JPEG files from a DCIM format folder (conforming to the DCF (design rule for camera file system) used in a digital camera) that is located in the route directory of the SD card.

(3) The TV returns the access point to the original setting.

The above series of processes is collectively executed, and the TV switches the access point without being noticed by the user.

Hereinbefore, we have explained the setting and connection method for connecting a medium from a consumer electronic apparatus (CE)(TV) provided with a WLAN function.

It is to be noted that the invention is not limited to the embodiments described above. The invention may be embodied in other specific forms without departing from its spirit and essential characteristics.

The invention may be embodied in various forms by appropriately combining two or more components disclosed in the embodiments described above. For example, some components may be deleted from all the components disclosed in the embodiments. It is permitted to appropriately combine the components of different embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to perform function setting for a medium capable of operating as an access point, comprising:
setting storage configured to store setting information of functions;
a processor configured to generate commands
to switch from a second access point other than the medium to the access point of the medium and
to operate the medium as the access point by using the setting information; and
a transmitter configured to transmit the command to the medium,
wherein the processor is further configured to generate a command to return from the access point of the medium to the second access point when terminating operation of the medium as the access point, and the transmitter is further configured to transmit the command to the second access point.

2. The information processing apparatus according to claim 1,
wherein the processor is configured to operate the medium as the access point by using a service set identifier.

3. The information processing apparatus according to claim 1,
wherein the setting information comprises an identifier of an access point, an encryption method, and an encryption key.

4. The information processing apparatus according to claim 1,
wherein the processor is configured to generate a command to reset a hold state as the command to return from the access point of the medium to the second access point.

5. An information processing method in an information processing apparatus configured to perform function setting for a medium capable of operating as an access point, comprising:
storing setting information of functions;
generating commands to switch from a second access point other than the medium to the access point of the medium, and to operate the medium as the access point by using the setting information; and
transmitting the command to the medium.
